(19) United States
(12) Patent Application Publication
(10) Pub. No.: US 2018/0232620 A1
(43) Pub. Date: Aug. 16, 2018

(54) PAPER SHEET HANDLING APPARATUS AND PAPER SHEET DETERMINING METHOD

(71) Applicant: FUJITSU FRONTECH LIMITED, lnagi (JP)

(72) Inventor: Kazuhisa YOSHIMURA, lnagi (JP)

(73) Assignee: FUJITSU FRONTECH LIMITED, lnagi (JP)

(21) Appl. No.: 15/950,493

(22) Filed: Apr. 11, 2018

Related U.S. Application Data
(63) Continuation of application No. PCT/JP2015/081660, filed on Nov. 10, 2015.

(51) Int. Cl. G06M 7/06; G07D 7/121; G07D 7/164; B65H 5/00; G01B 11/28; G06M 9/00

(52) U.S. Cl. CPC G06M 7/06; G07D 7/121; G07D 7/164; G06M 2207/02; G01B 11/285; G06M 9/00; B65H 2701/1912; B65H 5/002

(57) ABSTRACT

A paper sheet handling apparatus includes a calculation unit and a determination unit. The calculation unit calculates, on the basis of a thickness of a paper sheet that passes through a conveyance path and a contour of the paper sheet, a total area of a cumulative area of overlapping regions of the paper sheet in the contour and an area of a non-overlapping region of the paper sheet in the contour. The determination unit determines the number of the paper sheets on the basis of the calculated total area.

### CROSS-REFERENCE TO RELATED APPLICATION

This application is a continuation of International Application No. PCT/JP2015/081660, filed on Nov. 10, 2015, the entire contents of which are incorporated herein by reference.

### FIELD

The present invention relates to a paper sheet handling apparatus and a paper sheet determining method.

### BACKGROUND

As one of paper sheet handling apparatuses, there is a paper currency handling apparatus, as an example. The paper currency handling apparatus has a function to determine the number of paper currencies and denominations of the paper currencies inserted through a deposit/withdrawal port provided in the paper currency handling apparatus, and a function to distinguish serial numbers and genuineness of the paper currencies.

Conventionally, in the paper currency handling apparatus, the number of paper currencies passing through a conveyance path (hereinafter, the paper currencies may be referred to as “conveyed paper currencies”) is determined using a “thickness sensor”, and the number of the conveyed paper currencies is determined according to the thickness detected with the thickness sensor. For example, the number of the conveyed paper currencies is determined to be one when a thickness corresponding to one sheet of paper currency is detected with the thickness sensor, and the number of the conveyed paper currencies is determined to be two when a thickness corresponding to two sheets of paper currencies is detected with the thickness sensor.

Examples of related-art are described in Japanese Laid-open Patent Publication No. 05-046842A, in Japanese Laid-open Patent Publication No. 07-141547A, in Japanese Laid-open Patent Publication No. 2001-266105A, and in Japanese Laid-open Patent Publication No. 2003-288628A.

However, if the number of the conveyed paper currencies is determined according to only the thickness, the thickness of the conveyed paper currencies corresponds to two sheets of paper currencies in a case where the conveyed paper currency is one sheet of paper currencies folded in half. Therefore, the number of the conveyed paper currencies is erroneously determined to be two even though the number is actually one.

### SUMMARY

In one aspect of the disclosed embodiment, a paper sheet handling apparatus includes a calculation unit and a determination unit. The calculation unit calculates, on the basis of a thickness of a paper sheet that passes through a conveyance path and a contour of the paper sheet, a total area of a cumulative area of overlapping regions of the paper sheet in the contour and an area of a non-overlapping region of the paper sheet in the contour. The determination unit determines the number of the paper sheets on the basis of the calculated total area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a paper currency handling apparatus according to a first embodiment;

FIG. 2 is a diagram illustrating examples of denominations of the first embodiment;

FIG. 3 is a diagram for describing an operation of the paper currency handling apparatus of the first embodiment;

FIG. 4 is a diagram for describing an operation of the paper currency handling apparatus of the first embodiment;

FIG. 5 is a diagram for describing an operation of the paper currency handling apparatus of the first embodiment;

FIG. 6 is a diagram for describing an operation of the paper currency handling apparatus of the first embodiment;

FIG. 7 is a diagram for describing an operation of the paper currency handling apparatus of the first embodiment;

FIG. 8 is a diagram for describing an operation of the paper currency handling apparatus of the first embodiment;

FIG. 9 is a diagram illustrating an example of a reference table according to the first embodiment;

FIG. 10 is a flowchart for describing processing of a paper currency determination device according to the first embodiment; and

FIG. 11 is a diagram illustrating an example of a hardware configuration of the paper currency handling apparatus.

### DESCRIPTION OF EMBODIMENTS

Preferred embodiments of the present invention will be explained with reference to accompanying drawings. Note that the present invention is not limited by the following embodiments. In the embodiments, configurations having the same function and steps for performing the same processing are denoted with the same signs and overlapping description is omitted. Further, hereinafter, a paper currency handling apparatus will be described as an example of the paper sheet handling apparatus. Paper sheet is the generic term for paper currencies, cash vouchers, securities, cards, papers, and the like. In a case where an example of the paper sheet is a paper currency, a denomination of the paper currency is an example of a type of the paper sheet.

### First Embodiment

<Configuration of Paper Currency Handling Apparatus>

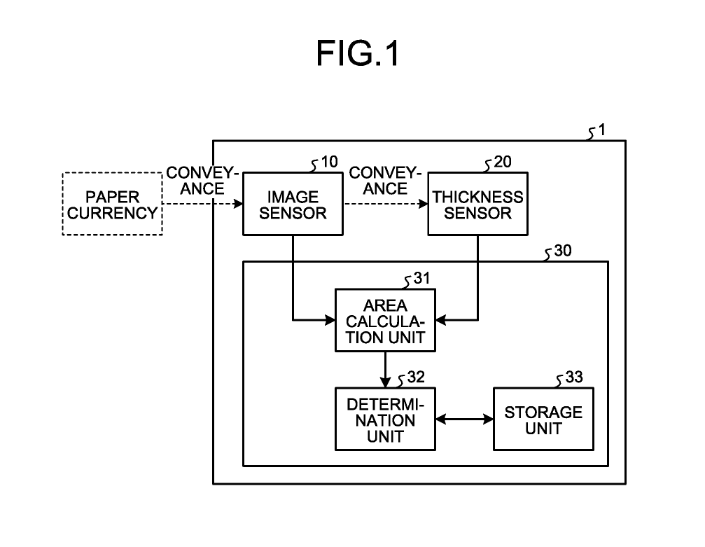

FIG. 1 is a block diagram illustrating an example of a configuration of a paper currency handling apparatus according to a first embodiment. In FIG. 1, a paper currency handling apparatus 1 includes an image sensor 10, a thickness sensor 20, and a paper currency determination device 30. The paper currency determination device 30 includes an area calculation unit 31, a determination unit 32, and a storage unit 33.

The image sensor 10 captures an image (hereinafter, may be called “conveyed paper currency image”) including a contour of the whole surface of the conveyed paper currency and shades of the whole surface of the conveyed paper currency, and outputs data of the captured conveyed paper currency image to the area calculation unit 31. For example, the image sensor 10 captures the whole surface of the conveyed paper currency in a state where the surface of the conveyed paper currency is irradiated with light, thereby to capture a transmission image of the whole surface of the conveyed paper currency. The captured transmission image includes the outline of the whole surface of the conveyed paper currency and the shades of the whole surface of the conveyed paper currency.

The thickness sensor 20 detects the thickness of the whole surface of the conveyed paper currency and outputs data of the detected thickness to the area calculation unit 31.

The area calculation unit 31 calculates, on the basis of the conveyed paper currency image and the thickness of the whole surface of the conveyed paper currency, a “total area” of a cumulative area of overlapping regions of the conveyed paper currency and an area of a non-overlapping region of the conveyed paper currency in the contour of the whole surface of the conveyed paper currency, and outputs the calculated total area to the determination unit 32. Details of the calculation of the total area will be described below.

The storage unit 33 stores a “reference table” that defines correspondence among the total area, the number of conveyed paper currencies, and the denomination of the conveyed paper currency. Details of the reference table will be described below.

The determination unit 32 determines the number and the denomination of the conveyed paper currencies by reference to the reference table on the basis of the total area calculated by the area calculation unit 31. Note that the determination unit 32 may determine only the number of the conveyed paper currencies without determining the denomination of the conveyed paper currencies. Details of determination of the number and the denomination of the conveyed paper currencies will be described below in detail.

<Operation of Paper Currency Handling Apparatus>

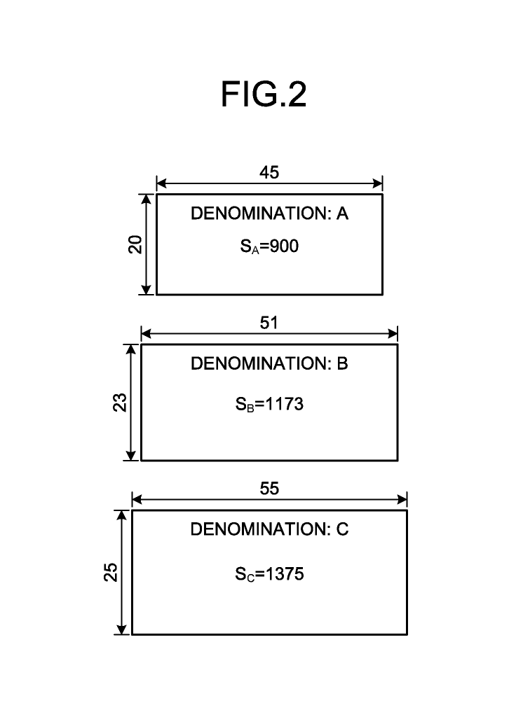

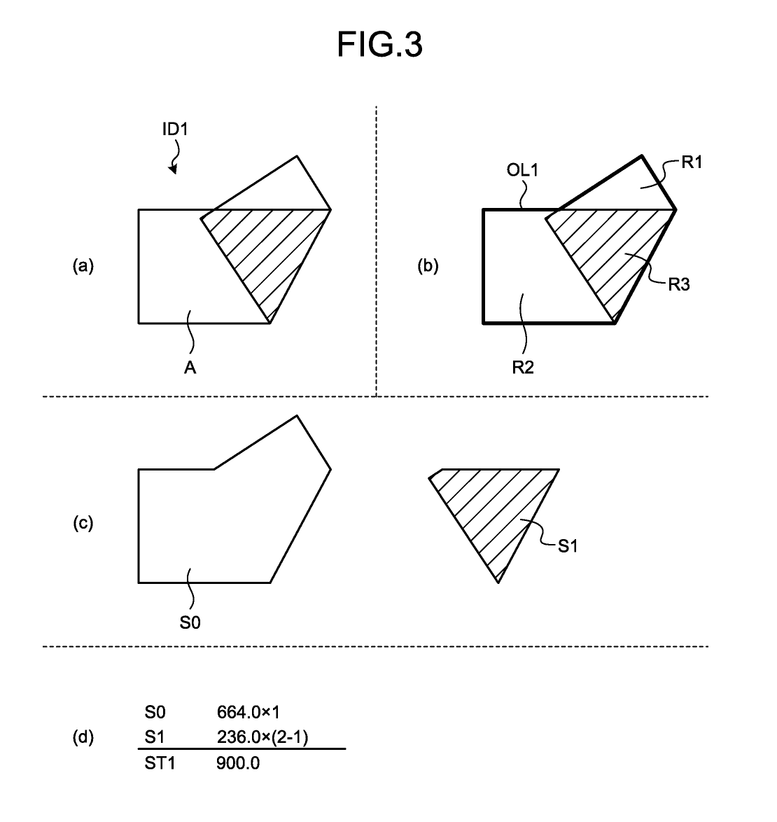

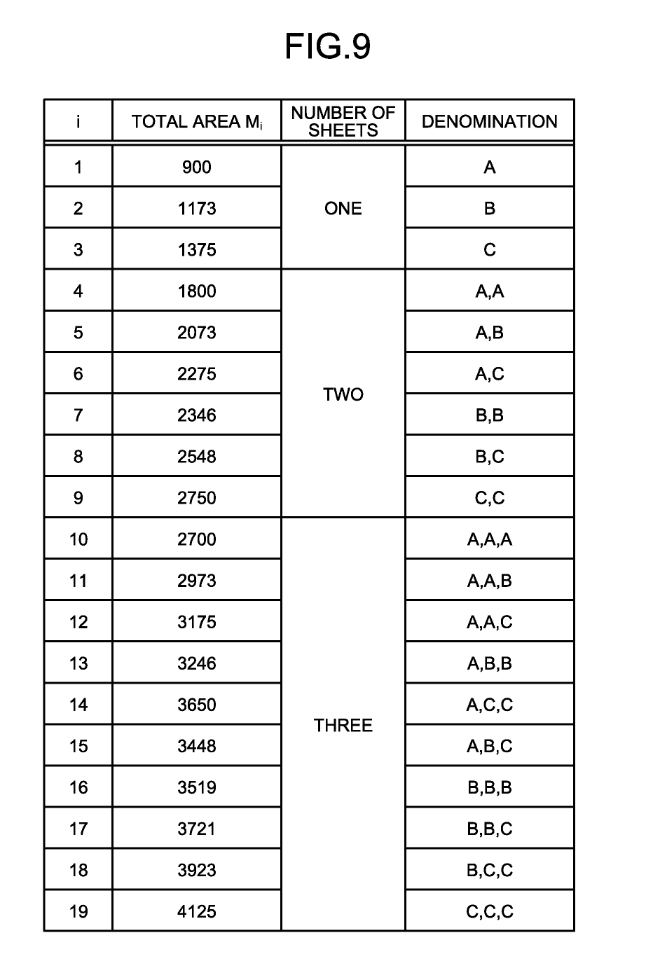

FIG. 2 is a diagram illustrating examples of denominations of the first embodiment, FIGS. 3 to 8 are diagrams for describing an operation of the paper currency handling apparatus of the first embodiment, and FIG. 9 is a diagram illustrating an example of a reference table according to the first embodiment. Note that the size of a paper currency described below is a virtual size (no unit) and is not a size of an actual paper currency.

As illustrated in FIG. 2, the paper currency handling apparatus 1 can handle paper currencies of three types of denominations A, B, and C, for example. In FIG. 2, for example, the size of the paper currency of the denomination A is “20 long×45 wide”, so an area SA of the denomination A is “900”. Meanwhile, the size of the paper currency of denomination B is “23 long×51 wide”, and thus an area SB of the denomination B is “1173”. Further, the size of the paper currency of the denomination C is “25 long×55 wide”, and thus an area SC of the denomination C is “1375”. The thicknesses of the denominations A, B and C are the same as one another.

Hereinafter, first to sixth operation examples will be described as operation examples in a case where the conveyed paper currency is any of the paper currencies of the denominations A, B, and C.

<First Operation Example: FIG. 3>

In FIG. 3(a), the conveyed paper currency is one sheet of the paper currency of the denomination A, and the one sheet of the paper currency of the denomination A is doubly folded. In the state illustrated in FIG. 3(a), the image sensor 10 captures a conveyed paper currency image ID1. Further, the thickness sensor 20 detects the thickness of the whole surface of the conveyed paper currency.

As illustrated in FIG. 3(b), the conveyed paper currency image ID1 includes a contour OL1 of the whole surface of the conveyed paper currency. In addition, the conveyed paper currency image ID1 includes the shades of the whole surface of the conveyed paper currency. That is, an image of a region R3 is darker than images of regions R1 and R2 in the contour OL1. Further, assume that the density of the images of the regions R1 and R2 is equal to or less than a threshold TH, and the density of the image of the region R3 is over the threshold TH. The threshold value TH indicates the density corresponding to the thickness per sheet of the paper currency. Therefore, the area calculation unit 31 determines that the regions R1 and R2 are the non-overlapping regions of the paper currency and the region R3 is the overlapping region of the paper currency in the contour OL1, on the basis of the shades of the whole surface of the conveyed paper currency. Further, the area calculation unit 31 determines that the thickness in the region R3 as the overlapping region, of the thicknesses of the whole surface of the conveyed paper currency (that is, the thicknesses of the whole surface in the contour OL1) detected by the thickness sensor 20, is the thickness of two sheets of the paper currencies on the basis of an output of the thickness sensor 20.

Therefore, as illustrated in FIGS. 3(c) and 3(d), the area calculation unit 31 calculates the area of a region (that is, R1+R2+R3) surrounded by the contour OL1 (that is, the area of the region corresponding to the thickness of one sheet of the paper currency) as “S0=664.0×1”. Further, the area calculation unit 31 calculates the area of the region R3 (that is, the area of a region corresponding to the thickness of two sheets of the paper currencies) as “S1=236.0×(2−1)”. Therefore, the area calculation unit 31 calculates a total area ST1 as “S0+S1=664.0+236.0=900.0”.

Here, the area per sheet of the paper currency in the region R3 as the overlapping region is “236.0”. Further, the region R3 is a region corresponding to the thickness of two sheets of the paper currencies. Therefore, the cumulative area of the two sheets of the paper currencies corresponding to the region R3 is “236.0×2=472.0”. When the total area ST1 is calculated using this cumulative area, the total area ST1 is calculated as “(664.0−236.0)+472.0=900.0”, which is the same as “S0 +S1=664.0+236.0=900.0”. Then, “664.0−236.0” is the area of the region R1+R2 as the non-overlapping region. Therefore, the total area ST1 corresponds to the sum of the cumulative area of the region R3 as the overlapping region and the area of the regions R1+R2 as the non-overlapping regions.

Next, the determination unit 32 specifies a total area that accords with the ST1=900.0 calculated by the area calculation unit 31 from among a plurality of total areas Mi set in the reference table on the basis of the total area ST1=900.0 by reference to the reference table illustrated in FIG. 9.

The reference table illustrated in FIG. 9 defines the correspondence among the total area Mi, the number of the conveyed paper currencies, and the denomination of the conveyed paper currencies. For example, as illustrated in FIG. 2, since the sum of an area SA of the denomination A and an area SB of the denomination B is “SA+SB=900+1173=2073”. Therefore, in the reference table, two sheets and the denominations A and B are associated with a total area M5=2073. That is, if the total area ST calculated by the area calculation unit 31 accords with the total area M5, it can be determined that one sheet of the paper currency of the denomination A and one sheet of the paper currency of the denomination B are conveyed.

Further, for example, according to FIG. 2, the total of the area twice the area SB of the denomination B and the area of the denomination C is “(SB×2)+SC=(1173×2)+1375=3721”. Therefore, in the reference table, three sheets and the denominations B, B, and C are associated with a total area M17=3721. That is, if the total area ST calculated by the area calculation unit 31 accords with the total area M17, it can be determined that two sheets of the paper currency of the denomination B and one sheet of the paper currency of the denomination C are conveyed.

Here, for example, when the total area ST calculated by the area calculation unit 31 falls within a range of ±α % of any of the plurality of total areas Mi set in the reference table, the determination unit 32 determines that any of the total areas Mi accords with the total area ST calculated by the area calculation unit 31. For example, “α=0.5%”. This also applies to the following second to sixth operation examples.

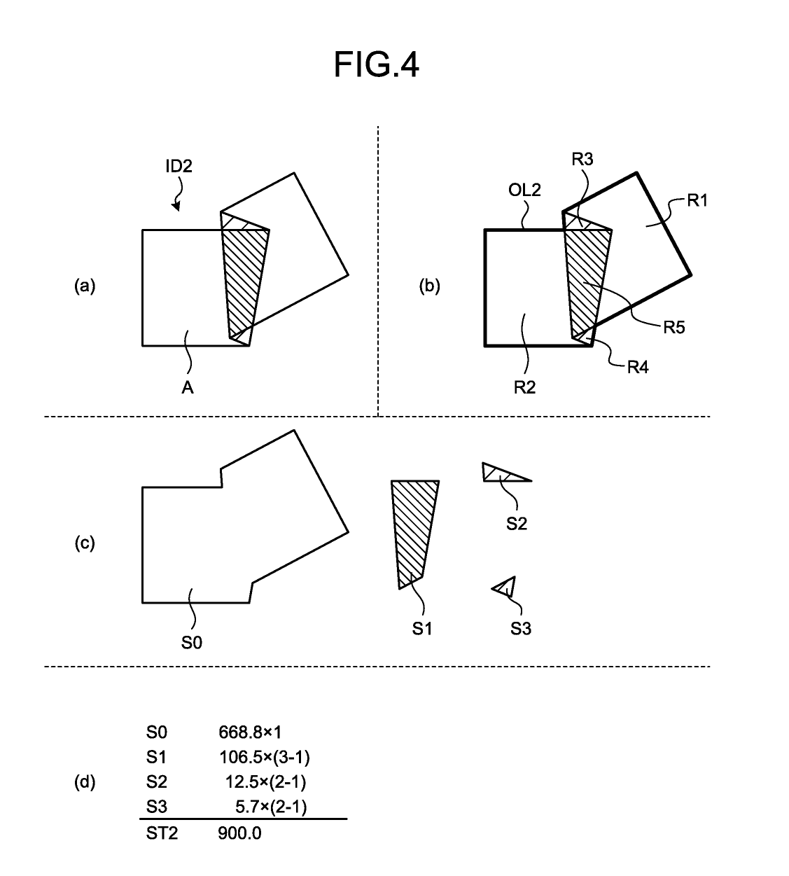

In the reference table, a total area M1=900 is associated with one sheet and the denomination A. Therefore, the determination unit 32 determines the number of the conveyed paper currencies to be one and the denomination of the conveyed paper currency to be the denomination A. That is, in the first operation example (FIG. 3), the determination unit 32 determines that one sheet of the paper currency of the denomination A is conveyed.

<Second Operation Example: FIG. 4>

In FIG. 4(a), the conveyed paper currency is one sheet of the paper currency of the denomination A, and the one sheet of the paper currency of the denomination A is triply folded. In the state illustrated in FIG. 4(a), the image sensor 10 captures a conveyed paper currency image ID2. Further, the thickness sensor 20 detects the thickness of the whole surface of the conveyed paper currency.

As illustrated in FIG. 4(b), the conveyed paper currency image ID2 includes a contour OL2 of the whole surface of the conveyed paper currency. In addition, the conveyed paper currency image ID2 includes the shades of the whole surface of the conveyed paper currency. That is, images of regions R3, R4, and R5 are darker than images of regions R1 and R2 in the contour OL2. Further, assume that the density of the images of the regions R1 and R2 is equal to or less than the threshold TH, and the density of the image of the regions R3, R4, and R5 is over the threshold TH. Therefore, the area calculation unit 31 determines that the regions R1 and R2 are the non-overlapping regions of the paper currency and the regions R3, R4, and R5 are the overlapping regions of the paper currency in the contour OL2, on the basis of the shades of the whole surface of the conveyed paper currency. Further, the area calculation unit 31 determines that the thickness in the regions R3 and R4 as the overlapping regions, of the thicknesses of the whole surface of the conveyed paper currency (that is, the thicknesses of the whole surface in the contour OL2) detected by the thickness sensor 20, is the thickness of two sheets of the paper currencies, and the thickness in the region R5 as the overlapping region is the thickness of three sheets of the paper currencies on the basis of an output of the thickness sensor 20.

Therefore, as illustrated in FIGS. 4(c) and 4(d), the area calculation unit 31 calculates the area of a region (that is, R1+R2+R3+R4+R5) surrounded by the contour OL2 (that is, the area of the region corresponding to the thickness of one sheet of the paper currency) as “S0 =668.8×1”. Further, the area calculation unit 31 calculates the areas of the regions R3 and R4 (that is, the areas of regions corresponding to the thickness of two sheets of the paper currencies) as “S2=12.5×(2−1)” and “S3=5.7×(2−1)”. Further, the area calculation unit 31 calculates the area of the region R5 (that is, the area of a region corresponding to the thickness of three sheets of the paper currencies) as “S1=106.5×(3−1)”. Therefore, the area calculation unit 31 calculates a total area ST2 as “S0+S1+S2+S3=668.8+213.0+12.5+5.7 =900.0”. Subsequent operations are the same as the first operation example. Therefore, the determination unit 32 determines the number of the paper currencies to be one and the denomination of the paper currency to be the denomination A. That is, in the second operation example (FIG. 4), the determination unit 32 determines that one sheet of the paper currency of the denomination A is conveyed.

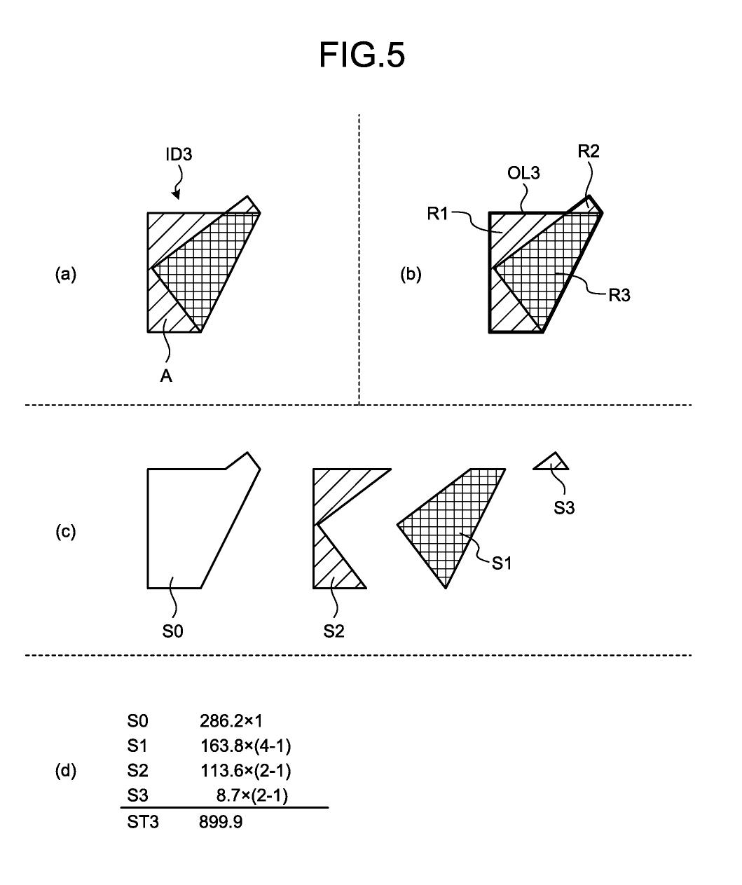

Here, the area per sheet of the paper currency in the region R3 as the overlapping region is “12.5”, and the area per sheet of the paper currency in the region R4 as the overlapping region is “5.7”. Further, each of the regions R3 and R4 is a region corresponding to the thickness of two sheets of the paper currencies. Therefore, the cumulative area of the two sheets of the paper currencies corresponding to the region R3+R4 is “(12.5×2)+(5.7×2=36.4”. Meanwhile, the area per sheet of the paper currency in the region R5 as the overlapping region is “106.5”. Further, the region R5 is a region corresponding to the thickness of three sheets of the paper currencies. Therefore, the cumulative area of the three sheets of the paper currencies corresponding to the region R5 is “106.5×3=319.5”. When the total area ST2 is calculated using these cumulative areas, the total area ST2 is calculated as “(668.8−12.5−5.7−106.5)+36.4+319.5=900.0” and is the same as the above “S0+S1+S2+S3=668.8+213.0+12.5+5.7=900.0”. Then, “668.8−12.5−5.7−106.5” is the area of the region R1+R2 as the non-overlapping region. Therefore, the total area ST2 corresponds to the sum of the cumulative area of the region R3+R4+R5 as the overlapping region and the area of the region R1+R2 as the non-overlapping region.

<Third Operation Example: FIG. 5>

In FIG. 5(a), the conveyed paper currency is one sheet of the paper currency of the denomination A, and the one sheet of the paper currency of the denomination A is folded four times. In the state illustrated in FIG. 5(a), the image sensor 10 captures a conveyed paper currency image ID3. Further, the thickness sensor 20 detects the thickness of the whole surface of the conveyed paper currency.

As illustrated in FIG. 5(b), the conveyed paper currency image ID3 includes a contour OL3 of the whole surface of the conveyed paper currency. In addition, the conveyed paper currency image ID3 includes the shades of the whole surface of the conveyed paper currency. That is, assume that the density of the image of all the regions in the contour OL3 is over the threshold TH. Therefore, the area calculation unit 31 determines that all the regions in the contour OL3 is the overlapping region of the paper currency. Further, the area calculation unit 31 determines that the thickness in the regions R1 and R2 as the overlapping regions, of the thicknesses of the whole surface of the conveyed paper currency (that is, the thicknesses of the whole surface in the contour OL3) detected by the thickness sensor 20, is the thickness of two sheets of the paper currencies, and the thickness in the region R3 as the overlapping region is the thickness of four sheets of the paper currencies on the basis of an output of the thickness sensor 20.

Therefore, as illustrated in FIGS. 5(c) and 5(d), the area calculation unit 31 calculates the area of a region (that is, R1+R2+R3) surrounded by the contour OL3 (that is, the area of the region corresponding to the thickness of one sheet of the paper currency) as “S0=286.2×1”. Further, the area calculation unit 31 calculates the areas of the regions R1 and R2 (that is, the areas of regions corresponding to the thickness of two sheets of the paper currencies) as “S2=113.6×(2−1)” and “S3=8.7×(2−1)”. Further, the area calculation unit 31 calculates the area of the region R3 (that is, the area of a region corresponding to the thickness of four sheets of the paper currencies) as “S1=163.8×(4−1)”. Therefore, the area calculation unit 31 calculates a total area ST3 as “S0+S1+S2+S3=286.2+491.4+113.6+8.7=899.9”. Subsequent operations are the same as the first operation example. Note that, α=0.5%. Therefore, the determination unit 32 determines the number of the paper currencies to be one and the denomination of the paper currency to be the denomination A. That is, in the third operation example (FIG. 5), the determination unit 32 determines that one sheet of the paper currency of the denomination A is conveyed.

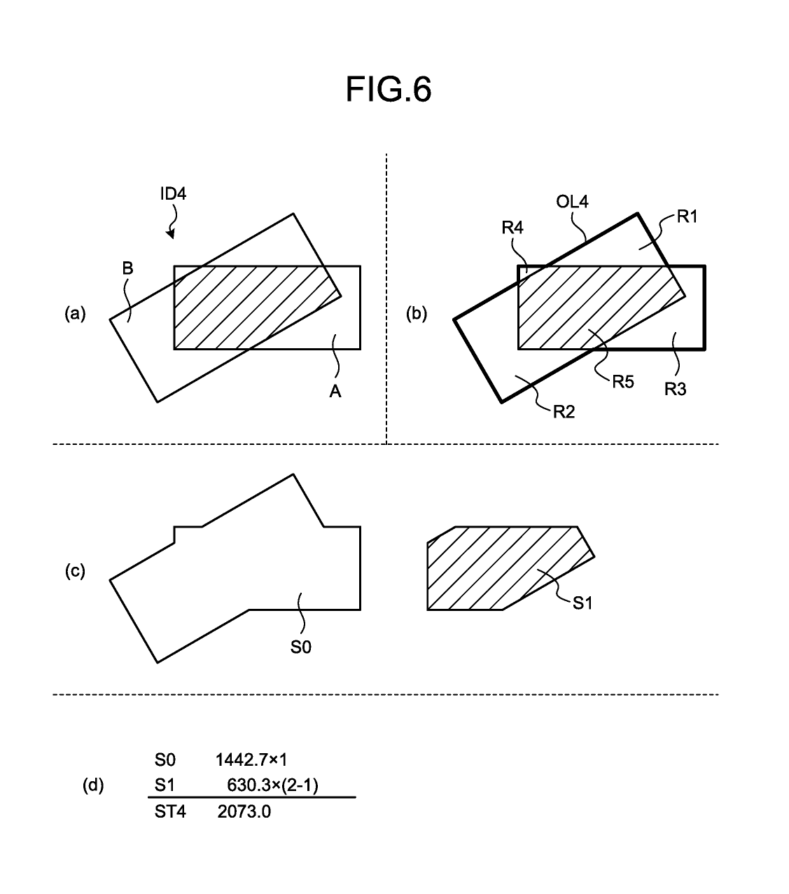

Here, the area per sheet of the paper currency in the region R1 as the overlapping region is “113.6”, and the area per sheet of the paper currency in the region R2 as the overlapping region is “8.7”. Further, each of the regions R1 and R2 is a region corresponding to the thickness of two sheets of the paper currencies. Therefore, the cumulative area of the two sheets of the paper currencies corresponding to the region R1+R2 is “(113.6×2)+(8.7×2)=244.6”. Meanwhile, the area per sheet of the paper currency in the region R3 as the overlapping region is “163.8”. Further, the region R3 is a region corresponding to the thickness of four sheets of the paper currencies. Therefore, the cumulative area of the four sheets of the paper currencies corresponding to the region R3 is “163.8×4=655.2”. When the total area ST3 is calculated using these cumulative areas, the total area ST3 is calculated as “(286.2−113.6−8.7−163.8)+244.6+655.2=899.9” and is the same as the above “S0+S1+S2+S3=286.2+491.4+113.6+8.7=899.9”. Then, “286.2−113.6−8.7−163.8=0.1≈6” is established, and therefore the area of the non-overlapping region in the contour OL3 is “0”. Therefore, the total area ST3 corresponds to the sum of the cumulative area of the region R1+R2+R3 as the overlapping region and the area “0” of the non-overlapping region.

<Fourth Operation Example: FIG. 6>

In FIG. 6 (a), the conveyed paper currencies are one sheet of the paper currency of the denomination A and one sheet of the paper currency of the denomination B, and a part of the paper currency of the denomination A and a part of the paper currency of the denomination B overlap with each other. Further, both of the paper currencies of the denominations A and B are not folded. In the state illustrated in FIG. 6(a), the image sensor 10 captures a conveyed paper currency image ID4. Further, the thickness sensor 20 detects the thickness of the whole surface of the conveyed paper currency.

As illustrated in FIG. 6(b), the conveyed paper currency image ID4 includes a contour OL4 of the whole surface of the conveyed paper currency. In addition, the conveyed paper currency image ID4 includes the shades of the whole surface of the conveyed paper currency. That is, an image of a region R5 is darker than images of regions R1 to R4 in the contour OL4. Further, assume that the density of the images of the regions R1 to R4 is equal to or less than the threshold TH, and the density of the image of the region R5 is over the threshold TH. Therefore, the area calculation unit 31 determines that the regions R1 to R4 are the non-overlapping regions of the paper currencies and the region R5 is the overlapping region of the paper currencies in the contour OL4, on the basis of the shades of the whole surface of the conveyed paper currencies. Further, the area calculation unit 31 determines that the thickness in the region R5 as the overlapping region, of the thicknesses of the whole surface of the conveyed paper currency (that is, the thicknesses of the whole surface in the contour OL4) detected by the thickness sensor 20, is the thickness of two sheets of the paper currencies on the basis of an output of the thickness sensor 20.

Therefore, as illustrated in FIGS. 6(c) and 6(d), the area calculation unit 31 calculates the area of a region (that is, R1+R2+R3+R4+R5) surrounded by the contour OL4 (that is, the area of the region corresponding to the thickness of one sheet of the paper currency) as “S0 =1442.7×1”. Further, the area calculation unit 31 calculates the area of the region R5 (that is, the area of a region corresponding to the thickness of two sheets of the paper currencies) as “S1=630.3×(2−1)”. Therefore, the area calculation unit 31 calculates a total area ST4 as “S0+S1=1442.7+630.3=2073.0”.

Here, the area per sheet of the paper currency in the region R5 as the overlapping region is “630.3”. Further, the region R5 is a region corresponding to the thickness of two sheets of the paper currencies. Therefore, the cumulative area of the two sheets of the paper currencies corresponding to the region R5 is “630.3×2=1260.6”. When the total area ST4 is calculated using this cumulative area, the total area ST4 is calculated as “(1442.7−630.3)+1260.6=2073.0”, which is the same as “S0+S1=1442.7+630.3=2073.0”. Then, “1442.7−630.3” is the area of the region R1+R2+R3+R4 as the non-overlapping region. Therefore, the total area ST4 corresponds to the sum of the cumulative area of the region R5 as the overlapping region and the area of the region R1 +R2+R3+R4 as the non-overlapping region.

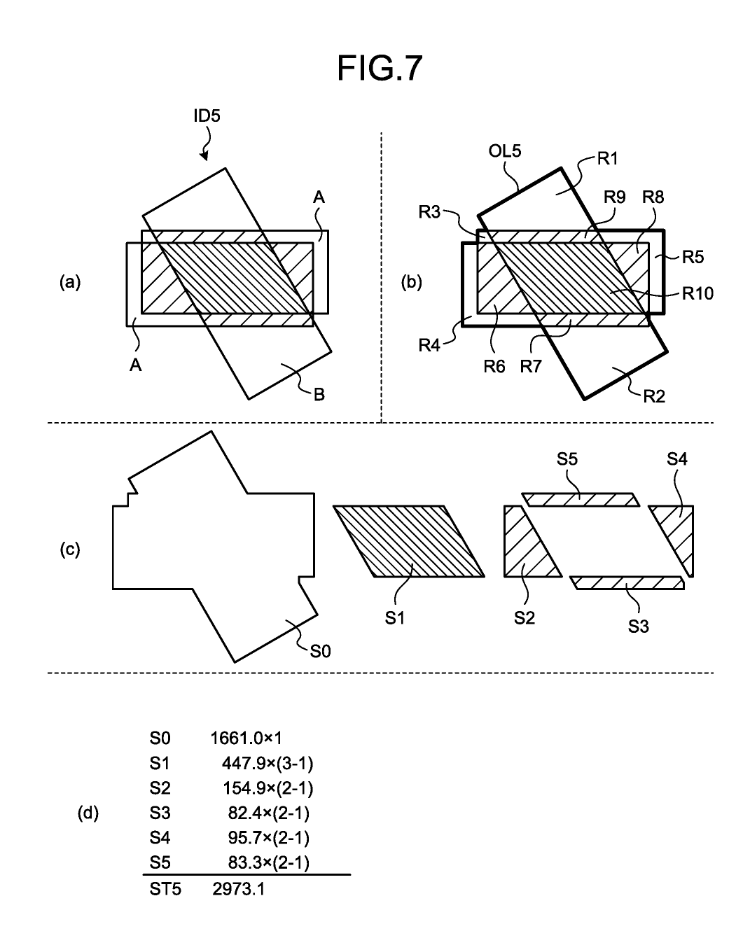

Next, the determination unit 32 specifies a total area that accords with the ST4=2073.0 calculated by the area calculation unit 31 from among a plurality of total areas Mi set in the reference table on the basis of the total area ST4=2073.0 by reference to the reference table illustrated in FIG. 9. In the reference table, a total area M5=2073 is associated with two sheets and the denominations A and B. Therefore, the determination unit 32 determines the number of the conveyed paper currencies to be two and the denominations of the conveyed paper currencies to be the denominations A and B. That is, in the fourth operation example (FIG. 6), the determination unit 32 determines that one sheet of the paper currency of the denomination A and one sheet of the paper currency of the denomination B are conveyed.

<Fifth Operation Example: FIG. 7>

In FIG. 7 (a), the conveyed paper currencies are two sheets of the paper currencies of the denomination A and one sheet of the paper currency of the denomination B, and a part of the paper currencies of the denomination A and a part of the paper currency of the denomination B overlap with one another. Further, both of the paper currencies of the denominations A and B are not folded. In the state illustrated in FIG. 7(a), the image sensor 10 captures a conveyed paper currency image ID5. Further, the thickness sensor 20 detects the thickness of the whole surface of the conveyed paper currency.

As illustrated in FIG. 7(b), the conveyed paper currency image ID5 includes a contour OL5 of the whole surface of the conveyed paper currency. In addition, the conveyed paper currency image ID5 includes the shades of the whole surface of the conveyed paper currency. That is, images of regions R6 to R10 are darker than images of regions R1 to R5 in the contour OL5. Further, assume that the density of the images of the regions R1 to R5 is equal to or less than the threshold TH, and the density of the images of the regions R6 to R10 is over the threshold TH. Therefore, the area calculation unit 31 determines that the regions R1 to R5 are the non-overlapping regions of the paper currencies and the regions R6 to R10 are the overlapping regions of the paper currencies in the contour OL5, on the basis of the shades of the whole surface of the conveyed paper currencies. Further, the area calculation unit 31 determines that the thickness in the regions R6 to R9 as the overlapping regions, of the thicknesses of the whole surface of the conveyed paper currency (that is, the thicknesses of the whole surface in the contour OL5) detected by the thickness sensor 20, is the thickness of two sheets of the paper currencies, and the thickness in the region R10 as the overlapping region is the thickness of three sheets of the paper currencies on the basis of an output of the thickness sensor 20.

Therefore, as illustrated in FIGS. 7(c) and 7(d), the area calculation unit 31 calculates the area of a region (that is, R1+R2+R3+R4+R5+R6+R7+R8+R9 +R10) surrounded by the contour OL5 (that is, the area of the region corresponding to the thickness of one sheet of the paper currency) as “SO=1661.0×1”. Further, the area calculation unit 31 calculates the areas of the regions R6, R7, R8, and R9 (that is, the areas of regions corresponding to the thickness of two sheets of the paper currencies) as “S2=154.9×(2−1)”, “S3=82.4×(2−1)”, “S4=95.7×(2−1)”, and “S5=83.3×(2−1)”. Further, the area calculation unit 31 calculates the area of the region R10 (that is, the area of a region corresponding to the thickness of three sheets of the paper currencies) as “S1=447.9×(3−1)”. Therefore, the area calculation unit 31 calculates a total area ST5 as “S0+S1 +S2+S3+S4+S5=1661.0+895.8+154.9+82.4+95.7 +83.3=2973.1”.

Here, the area per sheet of the paper currency in the region R6 as the overlapping region is “154.9”, the area per sheet of the paper currency in the region R7 as the overlapping region is “82.4”, the area per sheet of the paper currency in the region R8 as the overlapping region is “95.7”, and the area per sheet of the paper currency in the region R9 as the overlapping region is “83.3”. Further, each of the regions R6, R7, R8, and R9 is a region corresponding to the thickness of two sheets of the paper currencies. Therefore, the cumulative area of the two sheets of the paper currencies corresponding to the region R6+R7+R8+R9 is “(154.9×2)+(82.4×2)+(95.7×2) +(83.3×2)=832.6”. Meanwhile, the area per sheet of the paper currency in the region R10 as the overlapping region is “447.9”. Further, the region R10 is a region corresponding to the thickness of three sheets of the paper currencies. Therefore, the cumulative area of the three sheets of the paper currencies corresponding to the region R10 for three paper currencies is “447.9×3=1343.7”. When the total area ST5 is calculated using these cumulative areas, the total area ST5 is calculated as “(1661.0−154.9-82.4-95.7-83.3-447.9)+832.6+1343.7=2973.1” and is the same as the above “S0+S1+S2 +S3+S4+S5=1661.0+895.8+154.9+82.4+95.7+83.3=2973.1”. Then, “1661.0−154.9−82.4−95.7−83.3 −447.9” is the area of the region R1+R2+R3+R4+R5 as the non-overlapping region. Therefore, the total area ST5 corresponds to the sum of the cumulative area of the region R6+R7+R8+R9+R10 as the overlapping region and the area of the region R1+R2+R3+R4+R5 as the non-overlapping region.

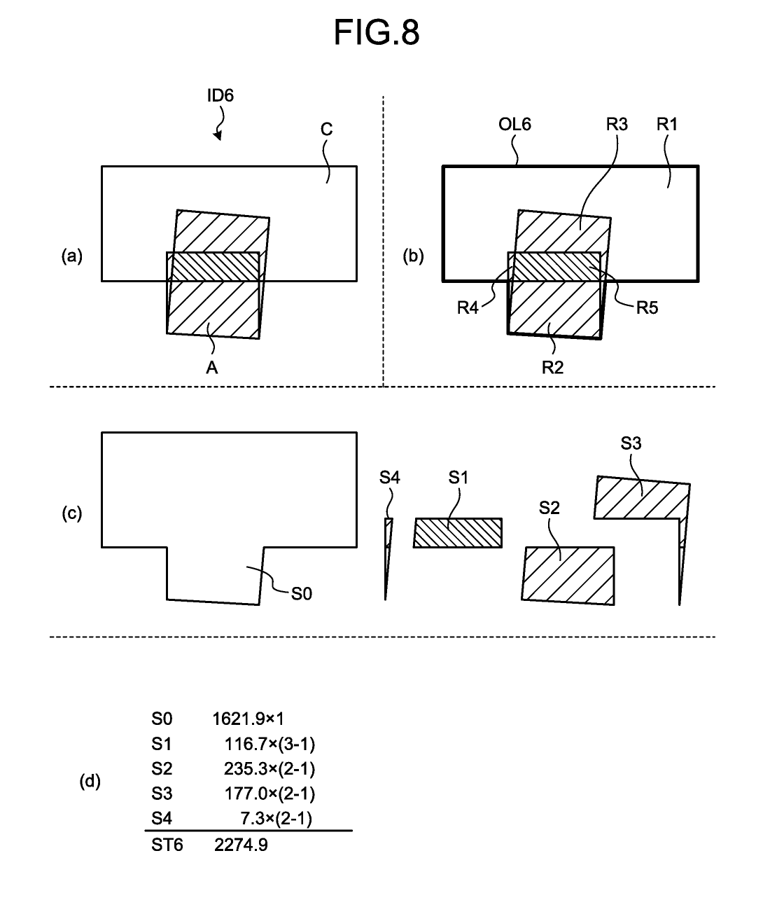

Next, the determination unit 32 specifies a total area that accords with the ST5=2973.1 calculated by the area calculation unit 31 from among a plurality of total areas Mi set in the reference table on the basis of the total area ST5=2973.1 by reference to the reference table illustrated in FIG. 9. In the reference table, a total area M11=2973 is associated with three sheets and the denominations A, A, and B, and α=0.5%. Therefore, the determination unit 32 determines the number of the conveyed paper currencies to be three and the denominations of the conveyed paper currencies to be the denominations A and B. That is, in the fifth operation example (FIG. 7), the determination unit 32 determines that two sheets of the paper currencies of the denomination A and one sheet of the paper currency of the denomination B are conveyed.

<Sixth Operation Example: FIG. 8>

In FIG. 8 (a), the conveyed paper currencies are one sheet of the paper currency of the denomination A and one sheet of the paper currency of the denomination C, and a part of the paper currency of the denomination A and a part of the paper currency of the denomination C overlap with each other. Further, while the paper currency of the denomination A is doubly folded, the paper currency of the denomination C is not folded. In the state illustrated in FIG. 8(a), the image sensor 10 captures a conveyed paper currency image ID6. Further, the thickness sensor 20 detects the thickness of the whole surface of the conveyed paper currency.

As illustrated in FIG. 8(b), the conveyed paper currency image ID6 includes a contour OL6 of the whole surface of the conveyed paper currency. In addition, the conveyed paper currency image ID6 includes the shades of the whole surface of the conveyed paper currency. That is, images of regions R2 to R5 are darker than an image of a region R1 in the contour OL6. Further, assume that the density of the image of the region R1 is equal to or less than the threshold TH, and the density of the images of the regions R2 to R5 is over the threshold TH. Therefore, the area calculation unit 31 determines that the region R1 is the non-overlapping region of the paper currency and the regions R2 to R5 are the overlapping regions of the paper currencies in the contour OL6, on the basis of the shades of the whole surface of the conveyed paper currencies. Further, the area calculation unit 31 determines that the thickness in the regions R2, R3, and R4 as the overlapping regions, of the thicknesses of the whole surface of the conveyed paper currency (that is, the thicknesses of the whole surface in the contour OL6) detected by the thickness sensor 20, is the thickness of two sheets of the paper currencies, and the thickness in the region R5 as the overlapping region is the thickness of three sheets of the paper currencies on the basis of an output of the thickness sensor 20.

Therefore, as illustrated in FIGS. 8(c) and 8(d), the area calculation unit 31 calculates the area of a region (that is, R1+R2+R3+R4+R5) surrounded by the contour OL6 (that is, the area of the region corresponding to the thickness of one sheet of the paper currency) as “S0 =1621.9×1”. Further, the area calculation unit 31 calculates the areas of the regions R2, R3, and R4 (that is, the areas of regions corresponding to the thickness of two sheets of the paper currencies) as “S2=235.3×(2−1)”, “S3=177.0×(2−1)”, and “S4=7.3×(2−1)”. Further, the area calculation unit 31 calculates the area of the region R5 (that is, the area of a region corresponding to the thickness of three sheets of the paper currencies) as “S1=116.7×(3−1)”. Therefore, the area calculation unit 31 calculates a total area ST6 as “S0+S1+S2+S3+S4=1621.9+233.4+235.3+177.0+7.3=2274.9”.

Here, the area per sheet of the paper currency in the region R2 as the overlapping region is “235.3”, the area per sheet of the paper currency in the region R3 as the overlapping region is “177.0”, and the area per sheet of the paper currency in the region R4 as the overlapping region is “7.3”. Further, each of the regions R2, R3, and R4 is a region corresponding to the thickness of two sheets of the paper currencies. Therefore, the cumulative area of the two sheets of the paper currencies corresponding to the region R2+R3+R4 is “(235.3×2)+(177.0×2)+(7.3×2)=839.2”. Meanwhile, the area per sheet of the paper currency in the region R5 as the overlapping region is “116.7”. Further, the region R5 is a region corresponding to the thickness of three sheets of the paper currencies. Therefore, the cumulative area of the three sheets of the paper currencies corresponding to the region R5 is “116.7×3=350.1”. When the total area ST6 is calculated using these cumulative areas, the total area ST6 is calculated as “(1621.9−235.3−177.0−7.3−116.7)+839.2+350.1=2274.9” and is the same as the above “S0+S1+S2+S3+S4=1621.9+233.4+235.3+177.0+7.3=2274.9”. Then, “1621.9−235.3−177.0−7.3−116.7” is the area of the region R1 as the non-overlapping region. Therefore, the total area ST6 corresponds to the sum of the cumulative area of the region R2+R3+R4+R5 as the overlapping region and the area of the region R1 as the non-overlapping region.

Next, the determination unit 32 specifies a total area that accords with the ST6=2274.9 calculated by the area calculation unit 31 from among a plurality of total areas Mi set in the reference table on the basis of the total area ST6=2274.9 by reference to the reference table illustrated in FIG. 9. In the reference table, a total area M6=2275 is associated with two sheets and the denominations A and C, and a=0.5%. Therefore, the determination unit 32 determines the number of the conveyed paper currencies to be two and the denominations of the conveyed paper currencies to be the denominations A and C. That is, in the sixth operation example (FIG. 8), the determination unit 32 determines that one sheet of the paper currency of the denomination A and one sheet of the paper currency of the denomination C are conveyed.

<Processing of Paper Currency Determination Device>

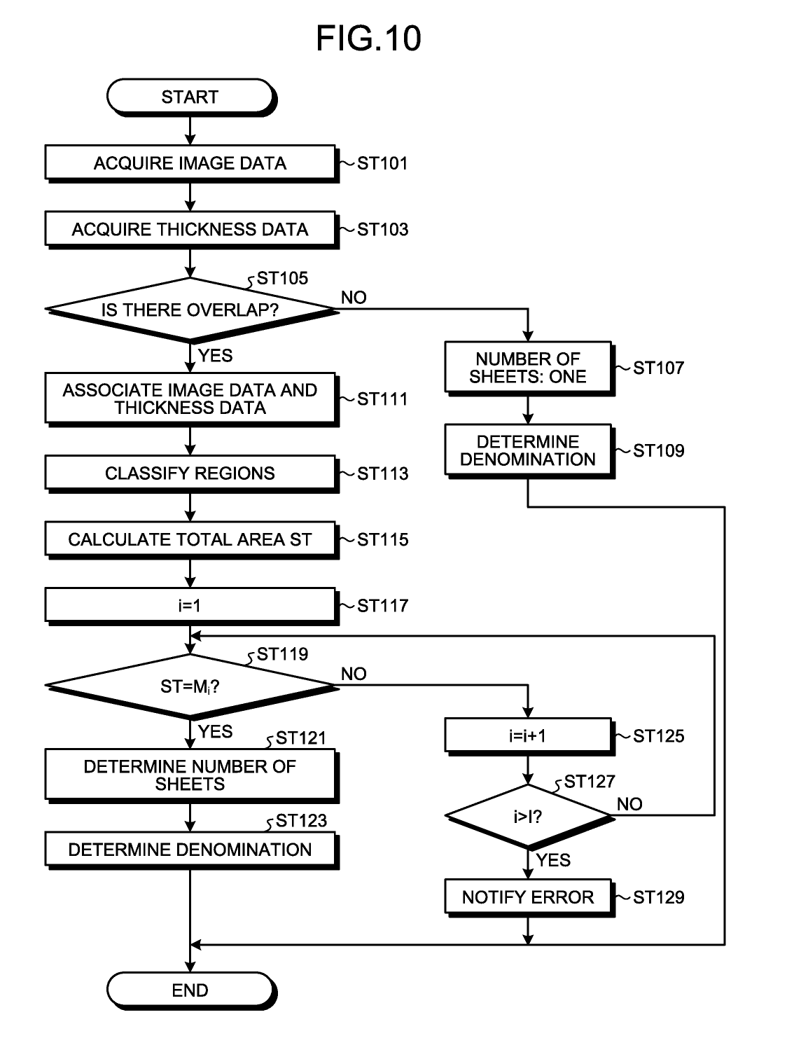

FIG. 10 is a flowchart for describing processing of the paper currency determination device according to the first embodiment.

In step ST101, the area calculation unit 31 acquires data (that is, image data) of the conveyed paper currency image from the image sensor 10.

In step ST103, the area calculation unit 31 acquires data of the thickness (that is, thickness data) of the whole surface of the conveyed paper currency from the thickness sensor 20.

In step ST105, the area calculation unit 31 acquires the shades of the whole surface of the conveyed paper currency from the image data, and determines whether the conveyed paper currency has an overlap on the basis of the acquired shades.

When the conveyed paper currency has no overlap (step ST105: No), the processing proceeds to step ST107, and the determination unit 32 determines the number of the conveyed paper currencies to be one.

In step ST109, the area calculation unit 31 calculates the area of one sheet of the conveyed paper currency, and the determination unit 32 determines the denomination of the conveyed paper currency on the basis of the area calculated by the area calculation unit 31. For example, when the calculated area is “900”, the determination unit 32 determines the denomination to be “A”. When the calculated area is “1173”, the determination unit 32 determines the denomination to be “B”. When the calculated area is “1375”, the determination unit 32 determines the denomination is determined to be “C” (see FIG. 2).

On the other hand, when the conveyed paper currency has an overlap (step ST105: Yes), the processing proceeds to step ST111, and the area calculation unit 31 specifies the overlapping region of the paper currency in the region of the whole surface of the conveyed paper currency by associating the image data with the thickness data.

In step ST113, the area calculation unit 31 classifies the area of the whole surface of the conveyed paper currency into the overlapping region of the paper currency and the non-overlapping region of the paper currency.

In step ST115, the area calculation unit 31 calculates the total area ST of the conveyed paper currency.

In step ST117, the determination unit 32 resets i to an initial value “1”.

In step ST119, the determination unit 32 refers to the reference table (FIG. 9) on the basis of the total area ST calculated by the area calculation unit 31, and determines whether the total area ST accords with the total area Mi set in the reference table.

When the total area ST accords with the total area Mi (step ST119: Yes), the processing proceeds to step ST121, and the determination unit 32 determines the number of sheets associated with the total area Mi in the reference table as the number of the conveyed paper currencies. For example, when the total area ST calculated in step ST115 accords with a total area M6 in the reference table, the determination unit 32 determines the number of the conveyed paper currencies to be two.

In step ST123, the determination unit 32 determines the denomination associated with the total area Mi in the reference table as the denomination of the conveyed paper currency. For example, when the total area ST calculated in step ST115 accords with the total area M6 in the reference table, the determination unit 32 determines the denominations of the conveyed paper currency to be the denomination A and the denomination C. That is, the determination unit 32 determines that one sheet of the paper currency of the denomination A and one sheet of the paper currency of the denomination C are conveyed.

On the other hand, when the total area ST does not accord with the total area Mi (step ST119: No), the processing proceeds to step ST125, and the determination unit 32 increments i by “1”.

In step ST127, the determination unit 32 determines whether i exceeds I. Here, “I” corresponds to the number of records set in the reference table, and “I=19” in the reference table illustrated in FIG. 9, for example. When i is equal to or less than I (step ST127: No), the processing returns to step ST119.

On the other hand, when i exceeds I (step ST127: Yes), the total area ST calculated in step ST115 does not accord with any total area Mi set in the reference table. Therefore, when i exceeds I (step ST127: Yes), the processing proceeds to step ST129, and the determination unit 32 notifies an error. For example, the determination unit 32 causes a display (not illustrated) of the paper currency handling apparatus 1 to display an error indicating that “the number of sheets is indeterminable”.

As described above, in the first embodiment, the paper currency handling apparatus 1 includes the area calculation unit 31 and the determination unit 32. The area calculation unit 31 calculates, on the basis of the thickness and the contour of the conveyed paper currency, the total area ST of the cumulative area of the overlapping regions of the conveyed paper currency in the contour of the conveyed paper currency and the area of the non-overlapping region of the conveyed paper currency in the contour of the conveyed paper currency. The determination unit 32 determines the number of the conveyed paper currencies on the basis of the total area ST calculated by the area calculation unit 31.

In doing so, even when a folded paper currency is included in the conveyed paper currencies, the number of the conveyed paper currencies can be accurately determined.

Further, in the first embodiment, the determination unit 32 determines the denomination of the conveyed paper currency on the basis of the total area ST calculated by the area calculation unit 31.

In doing so, even when a folded paper currency or a plurality of overlapping paper currencies is included in the conveyed paper currencies, the denomination of the conveyed paper currencies can be accurately determined.

Further, in the first embodiment, the paper currency handling apparatus 1 further includes the storage unit 33. The storage unit 33 stores the reference table that defines correspondence among the total area Mi, the number of the conveyed paper currencies, and the type of conveyed paper currencies. The determination unit 32 determines the number and the denomination of the conveyed paper currencies by reference to the reference table on the basis of the total area ST calculated by the area calculation unit 31.

In doing so, determination of the number of sheets and the denomination based on the total area ST can be simply and easily performed.

Further, in the first embodiment, the paper currency handling apparatus 1 further includes the image sensor 10. The image sensor 10 captures an image including the contour of the conveyed paper currency and the shades of the conveyed paper currency. The area calculation unit 31 classifies the overlapping region of the conveyed paper currency and the non-overlapping region of the conveyed paper currency in the contour on the basis of the contour and the shades included in the image captured by the image sensor 10.

Typically, the resolution of the thickness sensor 20 is often low in a conveying direction of the paper currency (that is, in a width direction and a depth direction of the conveyed paper currency). Therefore, when the overlapping region of the conveyed paper currency and the non-overlapping region of the conveyed paper currency are classified on the basis of the thickness detected by the thickness sensor 20, the accuracy of the classification may be low. If the accuracy of the classification between the overlapping region and the non-overlapping region is low, accurate calculation of the total area ST becomes difficult, and as a result, an error may be caused in the determination of the number and the denomination of the conveyed paper currencies. In contrast, the resolution of the image sensor 10 is generally higher than the resolution of the thickness sensor 20 in the conveying direction of the paper currency. Therefore, the overlapping region of the conveyed paper currency and the non-overlapping region of the conveyed paper currency are classified on the basis of the contour and the shades included in the image captured by the image sensor 10, whereby the classification can be accurately performed, and the calculation accuracy of the total area ST can be enhanced.

Further, in the first embodiment, the determination unit 32 determines the number of sheets corresponding to the total area ST as the number of the conveyed paper currency both in a case where a plurality of the paper currencies is stacked and conveyed, and in a case where the paper currency is folded.

In doing so, there is no need to perform special processing when the paper currency is folded, the processing being different from the processing performed when a plurality of paper currencies is stacked and conveyed. Therefore, the processing in both the cases is unified and becomes simple and easy.

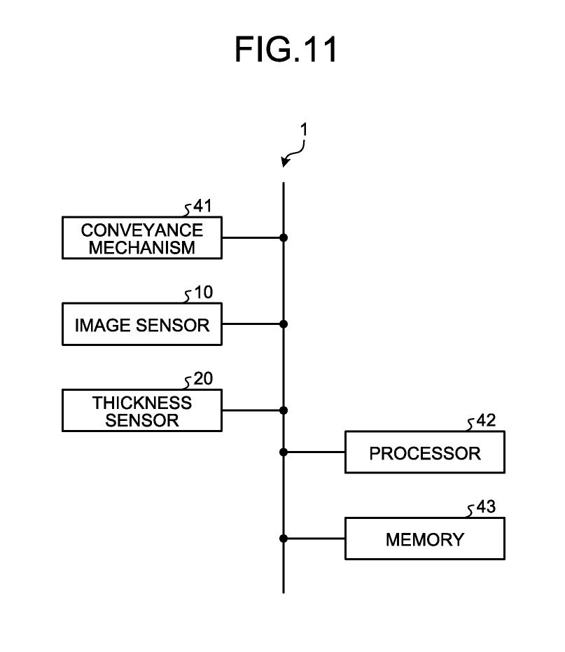

### Other Embodiments

[1] The disclosed technology can be applied to all kinds of paper sheets, such as cash vouchers, securities, cards, and papers, in addition to paper currencies.

[2] The paper currency handling apparatus 1 can be realized by the following hardware configuration. FIG. 11 is a diagram illustrating an example of a hardware configuration of the paper currency handling apparatus. As illustrated in FIG. 11, the paper currency handling apparatus 1 includes, as hardware configuration elements, a conveyance mechanism 41, the image sensor 10, the thickness sensor 20, a processor 42, and a memory 43. Examples of the processor 42 include a central processing unit (CPU), a digital signal processor (DSP), and a field programmable gate array (FPGA). Further, the paper currency handling apparatus 1 may have a large scale integrated circuit (LSI) including the processor 42 and a peripheral circuit. Examples of the memory 43 include a RAM such as an SDRAM, a ROM, and a flash memory.

The area calculation unit 31 and the determination unit 32 are realized by the processor 42, for example. The storage unit 33 is realized by the memory 43, for example.

[3 ] Each processing in the paper currency determination device 30 in the above description may be realized by causing the processor 42 to execute a program corresponding to each processing. For example, a program corresponding to each processing in the above description may be stored in the memory 43, and each program may be read from the memory 43 and executed by the processor 42. In addition, the programs are not necessarily stored in the memory 43 in advance. That is, for example, the programs may be recorded in advance on a portable recording medium such as a magnetic disk, an optical disk, an IC card, or a memory card connectable to the paper currency handling apparatus 1, and the programs may be read from the recording medium and executed by the processor 42. Further, for example, the programs may be stored in a computer, a server, or the like wirelessly or by wire connected to the paper currency handling apparatus 1 via the Internet, a LAN, a wireless LAN, or the like, and the programs may be read to and executed by the processor 42.

According to the disclosed aspect, the number of paper sheets can be accurately determined.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A paper sheet handling apparatus comprising:
a calculation unit configured to calculate, on the basis of a thickness of a paper sheet that passes through a conveyance path and a contour of the paper sheet, a total area of a cumulative area of overlapping regions of the paper sheet in the contour and an area of a non-overlapping region of the paper sheet in the contour; and
a determination unit configured to determine the number of the paper sheets on the basis of the calculated total area.

2. The paper sheet handling apparatus according to claim 1, wherein
the determination unit further determines a type of the paper sheet on the basis of the calculated total area.

3. The paper sheet handling apparatus according to claim 2, further comprising:
a storage unit configured to store a table that defines correspondence among the total area, the number of the paper sheets, and the type of the paper sheet, wherein
the determination unit determines the number and the type by reference to the table on the basis of the calculated total area.

4. The paper sheet handling apparatus according to claim 1, further comprising:
an image sensor configured to capture an image including the contour and shades of the paper sheet, wherein
the calculation unit classifies the overlapping region and the non-overlapping region in the contour on the basis of the contour and the shades included in the image.

5. The paper sheet handling apparatus according to claim 1, wherein
the determination unit determines a number corresponding to the total area as the number of the paper sheets both in a case where a plurality of the paper sheets is stacked and conveyed and in a case where the paper sheet is folded.

6. A paper sheet determining method comprising:
calculating, on the basis of a thickness of a paper sheet that passes through a conveyance path and a contour of the paper sheet, a total area of a cumulative area of overlapping regions of the paper sheet in the contour and an area of a non-overlapping region of the paper sheet in the contour; and
determining the number of the paper sheets on the basis of the calculated total area.
